(19) United States
(12) Patent Application Publication
(10) Pub. No.: US 2006/0025201 A1
(43) Pub. Date: Feb. 2, 2006

(54) Slot machine

(76) Inventor: Shawn Michael Van Asdale, Reno, NV (US)

Correspondence Address: Shawn M. Van Asdale, 2573 Rampart Terrace, Reno, NV, 89509, US

(21) Appl. No.: 11/137,728

(22) Filed: May 25, 2005

Related U.S. Application Data
(63) Continuation-in-part of application No. 10/899,992, filed on Jul. 27, 2004.

(51) Int. Cl. A63F 13/00

(52) U.S. Cl. 463/20

(57) ABSTRACT

A processor-controlled electronic gaming device includes a base game, e.g., a set of reels, and a secondary game, e.g., a mechanical secondary indicator such as a wheel with secondary values arranged in positions thereon and a mechanism for indicating one of the positions and its associated secondary value. Access to the secondary game is achieved by a variety of trigger conditions. After achieving a successful trigger, the player may be required to place a wager on the outcome of the secondary game in order to activate it. Upon activation of the secondary game, the gaming device selects at least one of the positions and may provide a player a secondary award.

### BACKGROUND OF THE INVENTION

The present invention relates generally to a gaming device and more particularly to a method for initiating and controlling a secondary game provided by a gaming device. Gaming devices are devices which upon a player making a wager, the player may win an award. Gaming devices include machines more commonly referred to as slot machines. There are many types of games that can be played on these gaming devices including but not limited to slots, video poker, keno, bingo, pachinko and blackjack.

Conventional gaming machines typically have a cabinet and a gaming display mounted inside the cabinet. The gaming display may be mechanical, such as a series of stepper reels that carry gaming symbols on the reels, or may be electronic such as a video display that is capable of generating video images of gaming symbols. Whether mechanical or electronic, the gaming display may be capable of generating images associated with a game, such as poker, blackjack, slots, keno, pachinko or bingo.

The gaming device is configured for a player to input something of value used to make a wager, which can include a standard denomination of currency, a ticket, and/or any other representation of currency or credit. Once the player inputs a wager, the player may then activate the device. Upon activation, in the case of a slot machine, a plurality of reels which are either mechanical or represented on the video screen spin and ultimately stop to display a random combination of some form of symbol, for example, numbers or symbols. If the display contains one of a plurality of winning combinations, the machine issues an award. The amount of award will typically depend on the winning combination that is achieved. The gaming machine then either releases money into a payout chute, issues a ticket, issues credits onto a credit meter, or indicates and awards the winning amount to the player in any suitable manner. Often the award amount is related to the initial amount wagered.

Similarly, with respect to video poker, once a player inputs a wager, a number of cards is displayed and ultimately the player's poker hand ranking is evaluated. With respect to other types of gaming devices discussed above, the appropriate display is shown to the player upon activation of the gaming device and awards are given based on the specific rules of each game. Whether the base game is a spinning-reel type slot machine or a poker game or another form of wagering game, an activation of the base game will generally be referred to as a spin of the base game.

The present invention concerns a gaming device that may offer the player the opportunity to play a secondary game. The secondary game may be a bonus game or another form of wagering game. The secondary game may be triggered or initiated in a number of ways. Prior art slot machines are known which trigger a bonus game upon the occurrence of a predetermined symbol or series of symbols in the base game. The present invention, while including such triggers, also embodies triggering events which do not use a predetermined symbol or predetermined series of symbols in the base game. In one embodiment not involving predetermined symbol(s), during one or more of the activations of the base game, one or more symbols are designated as triggering symbols. The triggering symbols may change from spin to spin of the base game, and may do so in a random manner. In another embodiment, a player is required to achieve a certain result on multiple successive activations of the base game in order to trigger the secondary game. In yet another embodiment of the present invention the secondary game may be triggered by an event, random or otherwise, that is unrelated to the symbols generated in the base game. When the event triggering the secondary game is unrelated to the symbols generated in the base game, it may be desirable to have the probability of triggering the secondary game increase with the amount of the player's wager or some portion thereof.

Another aspect of the present invention involves allowing the player the option of activating the secondary game by placing a secondary wager upon the occurrence of a triggering event. The amount to be wagered may be fixed and may have been provided to the player as a payout that accompanied the triggering event. Alternatively, the amount of the requisite wager may vary from activation to activation. When varying, the amount may be determined by the result of the previous base spin (e.g., such that the player must wager all or a portion of the winnings from the base spin). Preferably, whether fixed or variable, the amount of the wager may be relatively small compared to the expected payout received by activating the secondary game, such that it is always to the player's advantage to wager on the secondary game. In other embodiments, no wager is required for the secondary game. When operating in this fashion, the secondary game is a bonus game.

During the secondary game, the player may receive an additional award. Often a mechanical device or a video representation of a mechanical device is used to indicate the secondary amount. One such device that has become particularly popular is a mechanical device that rotates on an axis to alternately indicate one of several possible secondary amounts. This device may take the form of a wheel (which may include pointers that rotate around a circumference), a secondary reel or reels or the like.

Whether these secondary devices are mechanical or video representations of mechanical devices, today most all such devices are controlled by a microprocessor to provide extended odds as described in U.S. Pat. No. 5,788,573 incorporated herein by reference, and as a result, these secondary devices may offer the player the potential to win a very large award, even though the expected value of the secondary game is substantially less than the top award possible. The method described in U.S. Pat. No. 5,788,573 involves mapping each position of a bonus device to a larger number of virtual positions and then randomly selecting one of the virtual positions. Prior to the virtual mapping described in U.S. Pat. No. 5,788,573 mechanical bonus devices such as bonus wheels existed, but did not offer extended odds. One such device was the Monte Carlo slot machine made by Bally Gaming in the 1970's. The bonus wheel on the Monte Carlo had twelve different spots. In one version of this machine, the bonus wheel was activated whenever a player hit an initiator symbol on the base game within ten spins of previously hitting a different three-symbol combination on the base game. In this machine, the stop position of the bonus device is chosen by a mechanical randomizer. But because each spot had an equal chance of selection, there were only three values offered—ten (six spots), twenty (four spots) and fifty (two spots)—and the expected value of each spin of the bonus wheel was twenty coins. Because there is little variation between the bottom award, the top award and the average award offered by the Monte Carlo, today's player much rather prefers the mechanical bonuses with extended odds. Thus, secondary devices, including bonus devices, that offer the player the opportunity for a large reward add excitement to the game and provide increased enjoyment to the player. It would therefore be desirable to provide alternative methods of controlling these secondary devices to provide the desired outcomes. The present invention includes a number of new and improved methods of controlling the secondary device to achieve the desired extended odds.

### SUMMARY OF THE INVENTION

The present invention comprises a secondary game for play in conjunction with a base game. The secondary game preferably comprises a secondary mechanical device that is different than the base game. In most preferred embodiments, the secondary mechanical device is in the form of a rotating wheel that indicates win amounts by utilizing a pointer to select one of several visible amounts at the conclusion of the wheel spin. The invention includes a variety of methods for triggering the secondary device as well as a variety of methods for allowing the player to wager on the result of the secondary device or to activate the secondary device as a bonus game. Once the secondary device has been activated, the present invention achieves the extended odds for the secondary device that is desired by players by either, alone or in combination, virtually mapping results on the secondary device as is currently practiced by known bonus devices; individually evaluating each successive position on the secondary device against an individually determined probability of stopping at said position; or by rendering one or more of the positions ineligible prior to completing the secondary spin. Thus, a slot machine or other such gaming device employing the present invention can generally be described by referencing three main aspects of the game. First, what event acts as a trigger or initiator for the secondary device. Second, what options, if any the player is given with respect to the activation of the secondary device (e.g., if the player is required to wager on the secondary device, and if so, in what amounts). And finally, once the secondary device has been activated, what method is used to determine the value, if any, that is indicated by the secondary device. In the preferred embodiments the secondary device is a mechanical indicator, preferably in the form of a wheel, that rotates to indicate one or more of a plurality of symbols or amounts that will result in a payout being made to the player.

### Trigger Events

The following summarizes the various trigger events by which a player becomes eligible to play the secondary game disclosed in the present invention.

### Predetermined Initiation Symbols—Embodiment T1

In one embodiment of the present invention, the secondary game is triggered by the occurrence in the base game of one or more predetermined initiation symbols in a manner known in the art. The term “predetermined” or “preselected” in this sense means that the initiation symbols remain the same from play to play of the base game. As a result, the initiation symbols are known to the player prior to the player placing a wager on the base game. In order to trigger the secondary game, it may be necessary for a specific combination of multiple initiation symbols to occur or it may suffice for a player to achieve a combination having a single initiation symbol.

### Varying Initiation Symbols—Embodiment T2

In a preferred embodiment of the present invention, rather than predetermined initiation symbols, the initiation symbols may change from one play of the base game to the next. Thus, in this embodiment, it is possible for more than one symbol or even all symbols on a slot machine's reels to act as a trigger at some point in the life of the game. Which symbol or symbols will serve as initiation symbols for any given activation of the base game may be determined by the gaming machine, preferably in a random or pseudo-random fashion, or may be determined by player selection or some combination thereof. Preferably, once the base game is started, but before it is completed, the gaming machine will alert the player as to which symbols will serve as initiation symbols for this particular game. This may be accomplished in a variety of ways, including displaying an image of the active initiation symbols on the face of the machine or by highlighting the active initiation symbols on, for instance, a portion of the gaming machine's glass devoted to explaining the payouts associated with certain combinations. Preferably, the gaming machine will also provide audible indications of when an initiation symbol has occurred in the based game.

### Multiple-Spin Based Trigger—Embodiment T3

In yet another embodiment of the present invention, the secondary game can be triggered by multiple spins of the base game. For instance, in order to trigger the secondary game, the player may be required to achieve an initiation symbol or series of symbols in two separate spins of the base game. In effect then, the player is collecting initiation symbols/combinations. In such an arrangement, initiation symbols and combinations may either remain constant, at least until the secondary game is triggered, or may vary from spin to spin. The number of spins in which a player may complete a trigger condition once an initial initiation symbol or combination has been achieved may either be unlimited or limited in some manner.

A variety of methods may be used to limit the number of spins of the base game in which the player may satisfy the trigger condition. For instance, once an initial initiation symbol or combination is achieved in the base game the player may have a predetermined or randomly determined amount of time (e.g., thirty seconds) or number of spins (e.g., ten) to achieve a final initiation symbol or combination. Alternatively, individual results of base spins may expire, (i.e., be removed from the player's collection) after either a predetermined or randomly determined number of spins or an amount of time. Additionally, while a player is in the process of completing a multi-spin trigger condition, other events may occur, preferably as the result of spins during the base game, that either shorten or extend the limitation or that modify the criteria for completing a trigger condition.

### Non-Symbol Based Trigger—Embodiment T4

In yet another embodiment of the present invention, the secondary game is triggered by events independent of any symbols generated by play of the base game. Rather the secondary game may be triggered by the nth credit wagered on the base game, where n is a number randomly chosen. Alternatively, upon each spin of the base game, the gaming machine may generate a random number that may trigger the secondary game. The probability of success for said random number generation preferably is proportional to the amount of the player's wager on the base game.

### Activation Options

The following summarizes the various options that may be presented to the player following the completion of the trigger condition during the base game but before the player proceeds to the secondary game in different embodiments of the present invention.

### Bonus Game—Embodiment A1

In one embodiment of the present invention, the secondary game will be a bonus game. As used herein, the term “bonus” or “bonus game” has the definition typically understood by those skilled in the art in that the secondary game involves no risk of loss and thus, the player is guaranteed a win. Because a player's credit total can only increase by play of a bonus game, the player will typically not be given the option of whether or not to play the bonus game, i.e., to activate the secondary device which is now more specifically a bonus device.

### Fixed Secondary Wager—Embodiment A2

In a preferred embodiment of the present invention, the secondary game requires a wager in order for the secondary game to be played. In one particular embodiment, the amount that a player must wager on the outcome of the secondary game is fixed, e.g., thirty credits. Because it may be possible for the play of the secondary game to return less than the wagered amount, including zero credits, the player may be given the option of either playing the secondary game or foregoing play. However, in the preferred embodiment the expected return on a given wager on the secondary game will be greater than the expected return for the same size wager that the player experiences on the base game, and most preferably will be significantly greater than 1.0. Therefore, it is preferably to the player's advantage to play the secondary game at every opportunity. In one variation of this embodiment, the occurrence of the trigger condition may also involve the immediate award of credits to the player preferably at the conclusion of the base game. The credits awarded by the trigger may be random, but are more preferably fixed. When the credits awarded by the trigger condition are fixed, it may be preferable for the credits awarded by the trigger condition to be greater than or equal to the fixed amount required to be wagered on the secondary game. In this embodiment, the player is always assured of having adequate funds for a wager on the secondary game. However, it may be possible for the player to choose not to wager these credits on the secondary game.

### Variable Secondary Wager—Embodiment A3

In yet another embodiment where the player places a wager on the secondary game, the amount that the player wagers on the secondary game is variable rather than a fixed amount. The exact amount that is wagered may be chosen by the player, preferably within defined limits, or may be chosen by gaming machine or may be chosen by a combination of the player interacting with the gaming machine. In one variation of this embodiment, the prizes available by playing the secondary game, for instance prize amounts displayed on a secondary device such as a mechanical wheel, remain fixed in size and do not vary based upon the amount wagered on the secondary game. This particular variation may be used where the amount wagered on the secondary game is determined not by the player solely, but rather by the gaming machine, for instance requiring the player to wager either all or a portion of whatever winnings resulted from the play of the base game that preceded play of the secondary game. Alternatively, the gaming machine may randomly select an amount that the player must pay to activate the secondary game. The player may maintain the option of foregoing the secondary game (and thus the secondary wager) and preferably may make this decision once the required amount of the secondary wager has been communicated to the player. In some variations, as the amount wagered increases, the amount of the average prizes awarded increases. The exact amount of the increase in average prize need not be exactly proportional to the amount wagered, but preferably it will be roughly proportional. As in the fixed wager embodiments, it is preferable that the expected return associated with a wager on the secondary game typically be greater than the expected return of the base game, and most preferably will be greater than 1.0.

### Value Determination

The following summarizes the various methods by which the result of a secondary game that employs one or more secondary devices, such as a wheel, may be determined.

### Virtual Mapping—Embodiment V1

The first embodiment of the present invention utilizes the well known method of virtual mapping to determine the result of an activation of one or more secondary devices during the secondary game. These methods are described generally in U.S. Pat. Nos. 4,095,795 and 4,448,419 and are described specifically for bonus wheels in U.S. Pat. No. 5,788,573 which are incorporated by reference herein and which need no further discussion.

### Individual Evaluation—Embodiment V2

In one preferred embodiment a secondary device may be moved or rotated to successively indicate at least one of a plurality of positions where at least one of the positions has an award amount associated with it. Initially the secondary device may be moved or rotated at a relatively high rate of speed and subsequently at a low rate of speed. Once the secondary device reaches the low rate of speed the player may be able to view and comprehend the positions (and any amount associated with each position) successively indicated by the secondary device. Each position on the secondary device is assigned a probability of success in order to achieve the desired expected value for the secondary spin. As each position is indicated by the secondary device, the gaming machine's processor uses a random number generator to generate a probability number. Thus, for each position indicated, a new probability number may be generated. If the probability number is within the assigned range of probability of success for the indicated position, the secondary device stops. Thereby, indicating to the player the secondary amount won.

### Group Selection 1—Embodiment V3

In another alternative embodiment each position of the secondary device is assigned to at least one group such that at least one of the groups has a plurality of positions assigned to it. Each group is then assigned a probability of selection to achieve the desired expected value and a random number generator is used to select one of the groups. All positions associated with that group are then designated as eligible or active positions while those positions that are unassociated with the selected group are designated as ineligible or inactive positions. The secondary device is spun for a random amount of time, where the time of the spin is not necessarily intentionally weighted in any attempt to select one position more often than any other position. Once the random amount of spin time is exhausted, the secondary device will stop at the next available active position. Thereby, indicating to the player the secondary amount won.

### Group Selection 2—Embodiment V4

In another alternative embodiment, positions on the secondary device are assigned to groups and a single group is selected as before, resulting in the activation and deactivation of various positions. However, rather than selecting a position by spinning the secondary device for a random time and then stopping the secondary device at the next available activated position, each of the active positions is individually evaluated according to the method described in the individual evaluation embodiment.

### Group Selection 3—Embodiment V5

In another alternative embodiment, positions on the secondary device are assigned to groups and a single group is selected as before, however, based on the group selected, the secondary device will be spun and stopped in a specific orientation corresponding to the selected group. The positions within the group will then each be either adjacent to a plurality of selectively activated pointers or within the range of one or more movable pointers. Thus, positions outside of the selected group will be ineligible or inactive positions. One or more pointers will then be either activated or moved to indicate the selected position or positions.

### Elimination 1—Embodiment V6

In another alternative embodiment, a total secondary amount is chosen at the outset of the secondary game by the gaming machine's random number generator. All possible secondary amounts are weighted to provide the expected value desired by the manufacturer or operator of the gaming device. After the chosen amount is selected, at least all of the positions on the secondary device greater than the chosen amount are deactivated. Other amounts may be deactivated as well as desired. The secondary device then spins and stops on one of the active positions. Any number of known methods, including those previously disclosed, can be used to randomly select the indicated position. If the secondary amount associated with the indicated position is less than the original chosen amount, then the difference is used as a new chosen amount. Any additional positions with a value greater than the new chosen amount are deactivated and the player is awarded an additional bonus spin of the secondary device. This iterative process continues until the sum of all of the secondary amounts associated with the indicated positions is equal to the original chosen amount.

### Elimination 2—Embodiment V7

In another alternative embodiment, an original chosen amount is initially selected and a first spin of the secondary device is executed as in the previous embodiment. In this alternative, any difference between the value indicated by the secondary device and the original chosen amount is awarded to the player through an alternative bonus game. This bonus game may relate back to the secondary device by, for instance, multiplying the amount indicated by the secondary device by a number that will result in a product that equals the original chosen amount. Alternatively, the additional bonus game may be one of the many types of bonus games known as a second screen bonus that provides the player with an award. The award provided by the second screen bonus will preferably be at least the difference between the original chosen amount and the first value indicated.

### BRIEF DESCRIPTION OF THE DRAWINGS

FIG. 1A is a front perspective view of a gaming device using one embodiment of the present invention.

FIG. 1B is a front perspective view of a gaming device using varying initiation symbols in an alternative embodiment of the present invention.

FIG. 1C is a front perspective view of a gaming device using a multiple spin based trigger in another embodiment of the present invention.

FIG. 1D is a front perspective view of a gaming device using varying initiation symbols in another alternative embodiment of the present invention.

FIG. 1E is a front perspective view of a gaming device using varying initiation symbols selected by the player in another alternative embodiment of the present invention.

FIG. 2 is a schematic diagram of the electronic configuration of an embodiment of the gaming device of the present invention.

FIG. 3 is a diagram of a secondary device that may be used in one embodiment of the present invention.

FIG. 4 is a flowchart showing the steps according to a general embodiment of the present invention.

FIG. 5 is a table of values, probabilities and expected values that may be used in the individual evaluation method of the present invention.

FIG. 6 is a table of values, probabilities and expected values that may be used in one embodiment of the group selection method of the present invention.

FIG. 7 is a table of values, probabilities and expected values that may be used in one embodiment of the group selection method of the present invention.

FIG. 8 is a table of values, probabilities and expected values that may be used in one embodiment of the elimination method of the present invention.

FIG. 9 is a table of values, probabilities and expected values that may be used in one embodiment of the elimination method of the present invention.

FIG. 10 is a table of values, probabilities and expected values that may be used in an alternative embodiment of the group selection method of the present invention.

FIG. 11 is a table of values, probabilities and expected values that may be used in an alternative embodiment of the group selection method of the present invention.

### DETAILED DESCRIPTION OF THE INVENTION

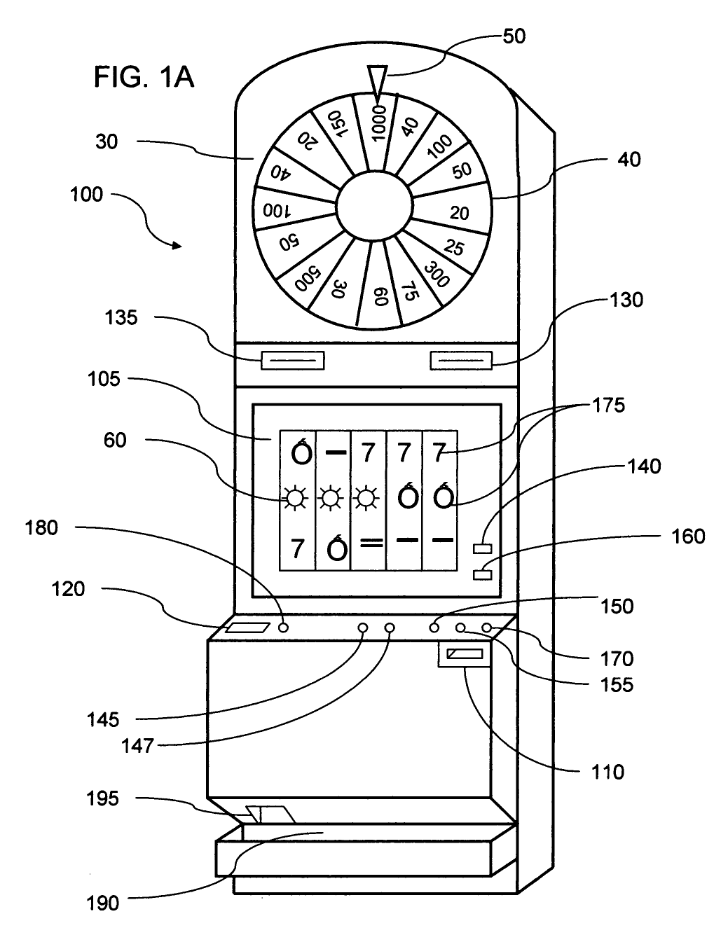

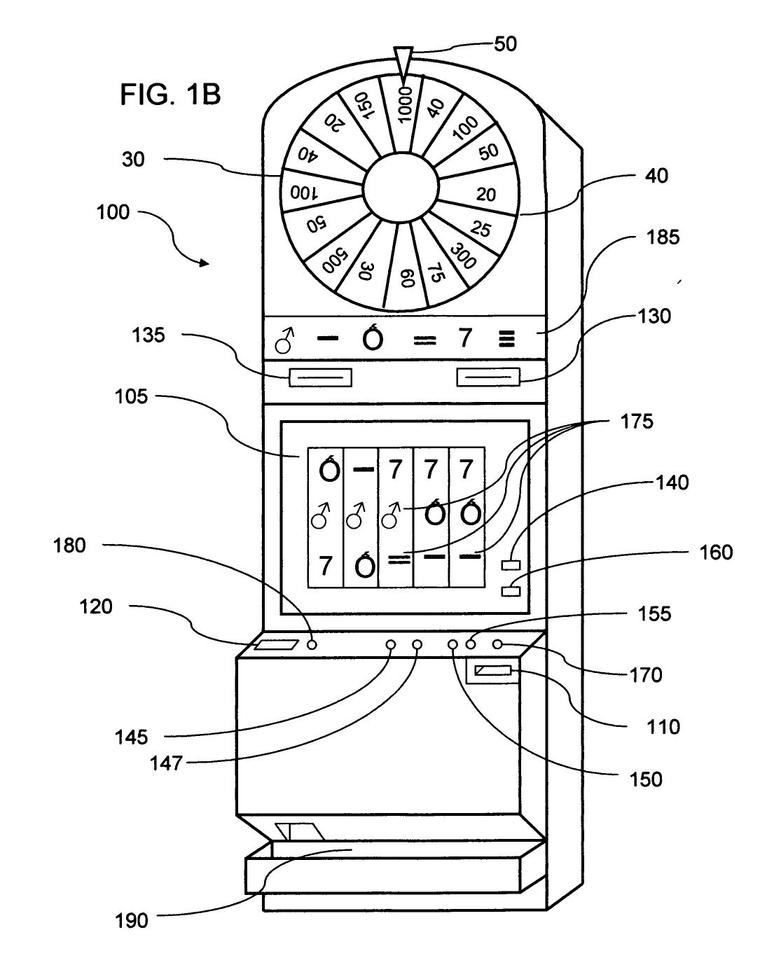

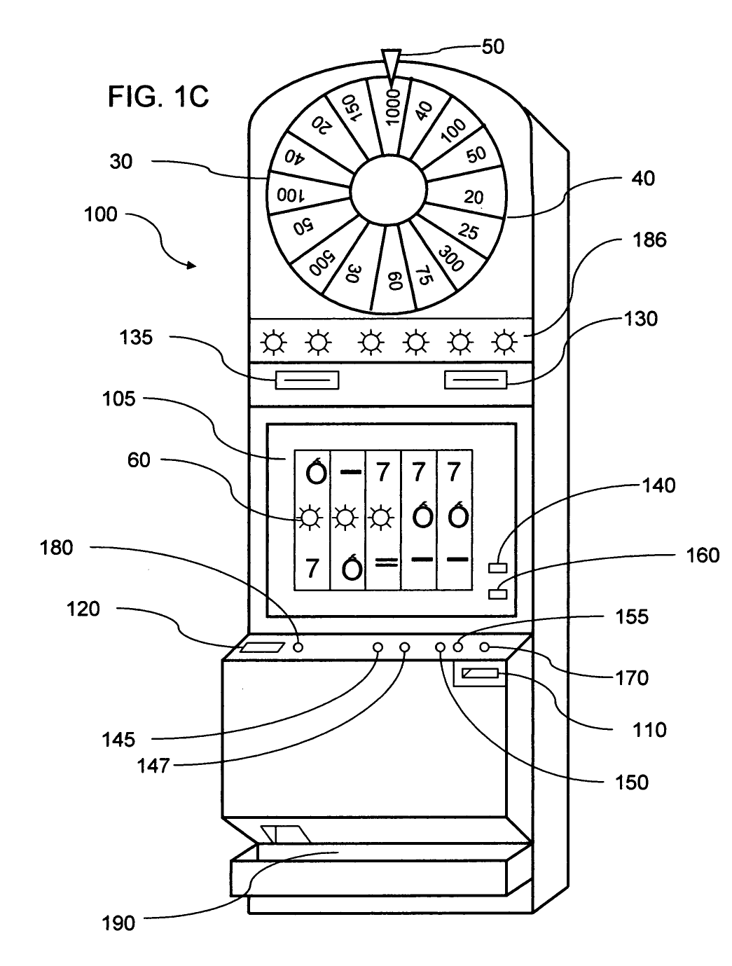

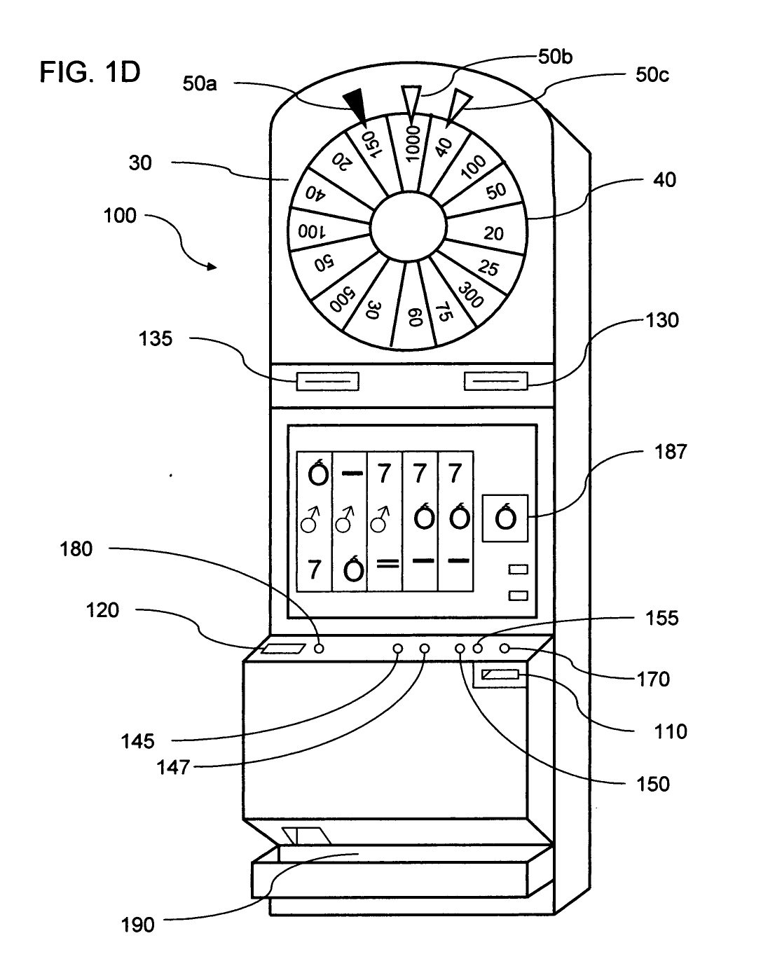

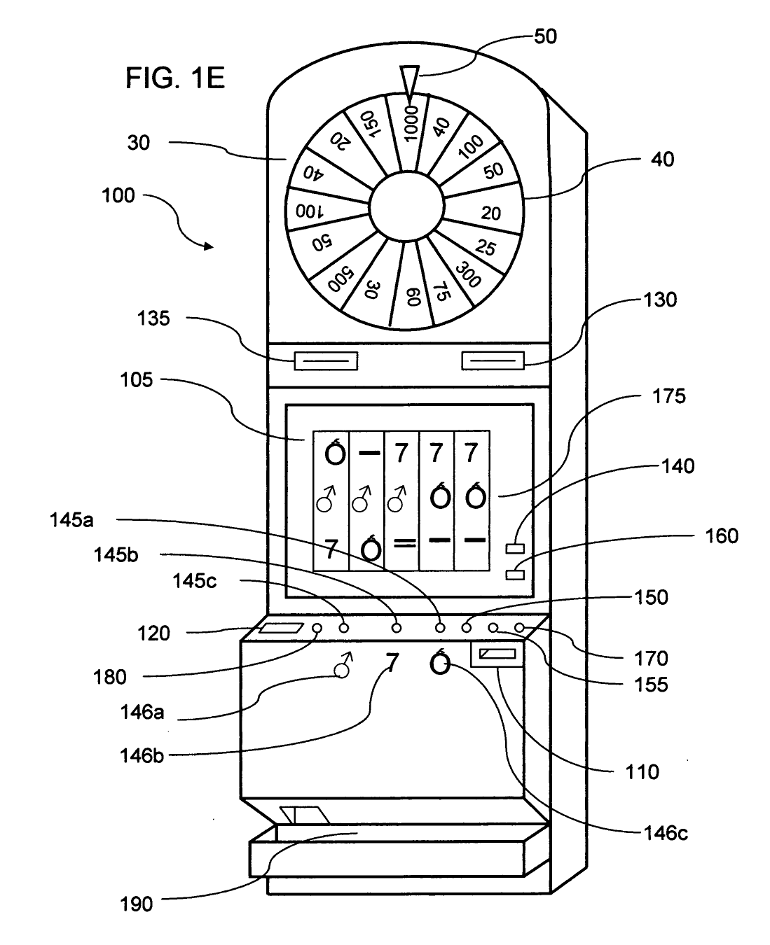

One embodiment of the present invention may be deployed on a gaming machine or gaming device 100 as illustrated in FIG. 1A. Gaming device 100 has the features of a conventional slot machine. The gaming device 100 shown in FIG. 1A is what is commonly referred to as an upright slot machine and the player can operate it while standing or sitting. Most often the gaming device 100 is preferably mounted on a cabinet. (Not shown.) Although an upright slot machine 100 is shown in FIG. 1A, it can be appreciated that the gaming device 100 can be any other style of gaming machine known in the art including, but not limited to a pub-style table-top or slant-top game in which a player can operate while sitting. The gaming device 100 can be constructed with varying cabinet and display designs.

Gaming device 100 can incorporate any primary game including, but not limited to slots, video poker, blackjack, keno or bingo. Further, there can be many types of secondary games associated with these primary games. The symbols and symbol used on and in gaming device 100 may be in mechanical, electrical, electronic or video form. Gaming device 100 shown in FIG. 1A has a video display 105 for displaying symbols.

It should be appreciated that the display devices may display any visual representation or exhibition, including but not limited to video images or movement of physical objects such as mechanical reels and wheels. The display devices can be a video monitor or screen, a liquid crystal display or any other display mechanism. Furthermore, it should be appreciated that these display devices may preferably include touchscreens.

As shown in FIG. 1A, gaming device 100 preferably includes one or more wager accepting mechanisms. The primary wager accepting mechanism on the gaming device 100 shown in FIG. 1A may be a bill validator 110. The bill validator 110 may also accept other forms of payment including, but not limited to tickets, smart cards, debit cards and credit cards. Alternatively, some of these forms of payment may be accepted through a card reader 130. The card reader 130 may include any type of card reading device, such as a magnetic card reader or an optical card reader. The player will insert a card, such as a player tracking card or a credit card into the card reader 130 which will then read data from the card. The card reader 130 may be used to read and/or write from and/or to the inserted card. There is also a coin slot 120 on the gaming device 100 in which a player can insert coins or tokens.

After a player inserts money in the gaming device 100, either via the coin slot 120, the bill validator 110 or the card reader 130, a number of credits corresponding to the amount deposited is shown in a credit display 140. After money is credited to the machine 100 and shown on the credit display 140, the player then determines the wager amount. The machine 100 may have any number of mechanisms known in the art for allowing a player to determine his wager. For example, in the case of a multi-line slot game as shown in FIG. 1A, the player may determine the amount of paylines he wishes to wager on by pushing the bet one line button 155 a number of times corresponding to the number of paylines he wishes to bet. Then the player may determine the wager amount per payline by pushing the bet one button 170 an appropriate number of times. The product being the player's total wager. As the player is selecting the wager amount, this wager amount is displayed on a bet display 160. As the bet display 160 amount is incrementing, the credit meter 140 amount is decreasing by the corresponding amount.

Although FIG. 1A displays a five reel video slot machine with three rows of symbols, it can be appreciated that any configuration of video or mechanical reels can be used in the gaming device 100 according to the invention as well as any corresponding number of paylines as known in the art. Each reel often displays symbols or symbol 175. The symbols may include cherries, sevens, bars and the like traditionally used on slot machines or any other symbol created by the manufacturer. The specific display of the symbols 175 after each play determine the payout, if any made by the gaming device 100.

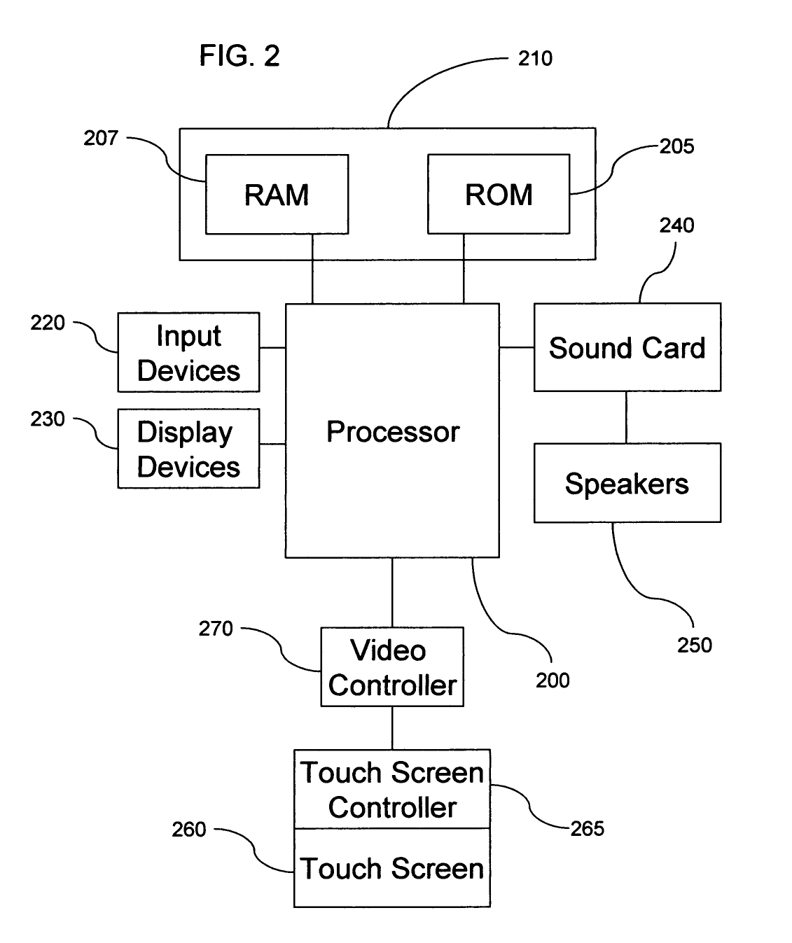

FIG. 2 is a block diagram of the general electronic configuration that may be incorporated in the gaming device 100. The configuration preferably includes a processor 200. The processor 200 is preferably a microcontroller-based platform or microprocessor which is capable of displaying images, symbols and other symbol such as images of people, characters, places, things and faces of cards. One or more secondary processors may also be employed in conjunction with the primary processor to control certain aspects of the game function.

The gaming device 100 also includes a memory device 210 for storing program code or other data. This memory device 210 can include both read only memory (ROM) 205 and random access memory (RAM) 207. One of the functions performed by a program or sub-program in the processor 200 may be a random number generator (RNG) using any of several methods known to those skilled in the art. In addition to the memory device 210, the electronic configuration of the gaming device 100 may also include one or more input devices 220, one or more display devices 230, a sound card 240, and one or more speakers 250.

The input devices 220 may include but are not limited to a primary spin button 145, a secondary spin button 147, a bet one credit button 170, a max bet button 150, a cash out button 180 and a bet one line button 155. In situations where a touch screen 260 is used, a touch screen controller 265 and touch screen 260 are connected to a video controller 270 and the processor 200.

Although FIG. 2 shows the processor 200 and memory device 210 residing on the gaming device 100, it should be appreciated that it is possible for both the processor 200 and memory device 210 to reside at a central location instead of at the gaming device 100. In such a situation, a network server may be used to communicate to the gaming device over an Internet connection, local area network (LAN), or wide area network (WAN). The processor 200 and memory device 210 are generally referred to herein as the controller.

Once the player has finalized his wager amount, the player may initiate play by pressing the primary spin button 145. In response to play initiation, the gaming device 100 randomly displays a plurality of symbols 175 on the video display 105. In the video configuration of the gaming device 100 shown in FIG. 1A, the symbols 175 are displayed by simulating the spinning of the video reels as is known in the art. As used herein, “reels” will thus include both mechanical and video reels unless one type is specifically referenced. The processor 200 evaluates the displayed symbols 175 on the selected paylines to determine if any winning combinations occurred. For each winning combination the credit meter 140 is incremented a predetermined amount.

In the preferred operation of the gaming device, when a player no longer wishes to play, he activates the cash out button 180, which results in any amount on the credit meter 140 being paid to the player either by crediting a player's account, issuing a ticket by a ticket printer 135 or by depositing coins or tokens into a coin tray 190 through a coin chute 195.

In addition to winning credits on the base game or primary game in this manner, the gaming device 100 also gives players the opportunity to win credits in a secondary game. The secondary game may primarily be displayed to the player using a secondary device 30. Preferably the secondary device 30 is a mechanical device comprising a wheel 40. The wheel 40 is divided into several areas. In a preferred embodiment each area is associated with an amount. The secondary device also comprises a means for indicating at least one of the areas. In the gaming device 100 shown in FIG. 1A, a single pointer 50 indicates one of the areas on the wheel 40. Preferably the pointer 50 is stationary. However, in other embodiments of the present invention, the pointer 50 may move to indicate one or more areas of the secondary device 30. Alternatively, as shown in FIG. 1D, the secondary device may include a plurality of selectively activated pointers 50a, 50b and 50c. Although each of these pointers may indicate an area of the secondary device 30, in one embodiment, only one selectively activated pointer 50a will be active at the conclusion of the secondary spin. The identity of the selectively activated pointer 50a may be communicated to the player by using LEDs to illuminate the active pointer 50a. In this manner, the processor 200 may alternatively activate and deactivate the plurality of selectively activated pointers 50a, 50b and 50c to indicate a plurality of possible outcomes of the secondary device 30 before a final selection is made. It would also be possible to indicate an area of the wheel by illuminating the specific area by using, for instance, LEDs or the like. It can be appreciated that a wheel is one of many embodiments for this secondary device, but that any mechanical secondary device or video representation of a secondary device may be used.

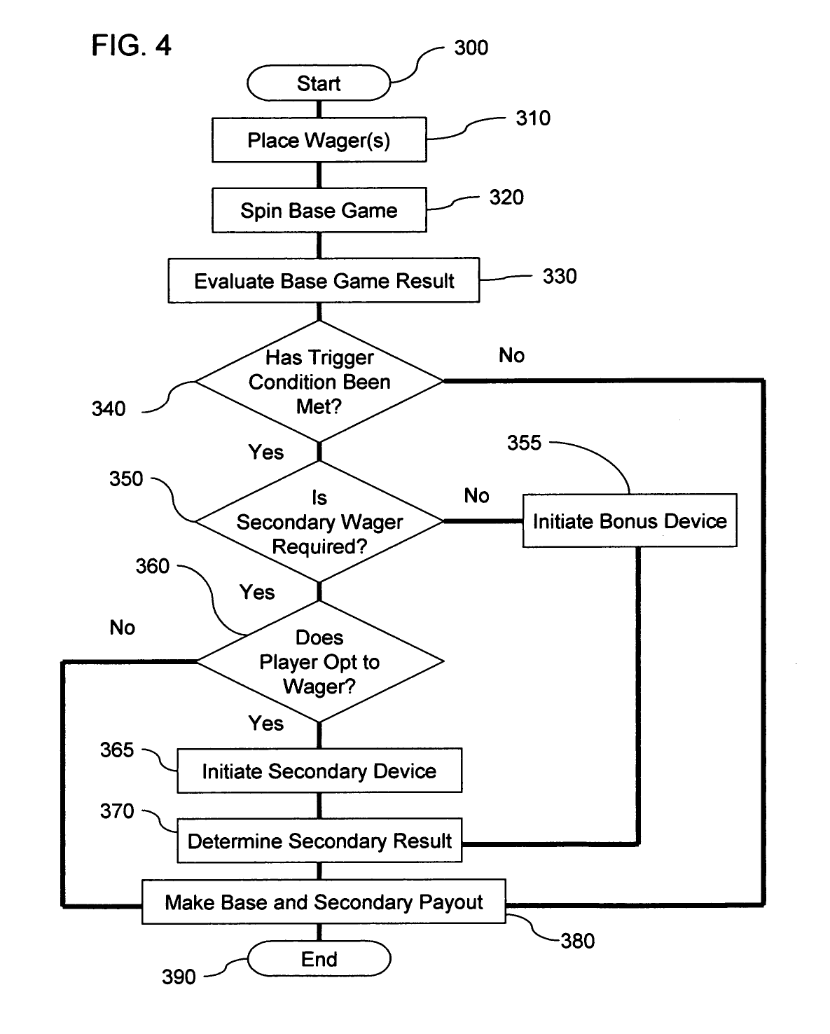

Referring now to FIG. 4, the general logic of a gaming device 100 incorporating the present invention will now be described. It should be appreciated by those skilled in the art, that although the steps shown in the flowchart on FIG. 4 are in a preferred order, no specific order of operation is generally required. At step 310 the player places at least an initial wager on the base game. At step 320 the base game is initiated and the result of the base game spin is evaluated at step 330. In some embodiments, any payouts resulting from the base game could be paid at this step. At step 340 the processor 200 determines if the trigger condition for the secondary game has been satisfied, this may or may not depend upon the result of the just-completed spin of the base game. If the trigger condition has not been satisfied, the game proceeds to step 380 where any payout resulting from the spin of the base game is made, preferably by incrementing the credit meter 140 of the gaming device 100. If the trigger has been satisfied, the game proceeds to step 350. At step 350 the gaming device 100 determines if the player is required to place an additional wager to activate the secondary device 30. This may depend on the nature of the successful trigger. For instance, one combination on the base game may activate the secondary device 30 as a bonus requiring no secondary wager while another combination may optionally allow the player to wager on the activation of the secondary device 30. As an example, three or fewer initiation symbols may trigger the secondary device 30 but require a secondary wager, while four or more symbols would allow the player to initiate the secondary device 30 without placing a wager. If no wager is required, i.e., if the secondary game is a bonus game, the gaming device 100 will proceed to step 355 where the bonus device 30 is initiated. This initiation may occur automatically or after some player interaction, e.g., by hitting a secondary spin button 147.

If a secondary wager is required, the game proceeds to step 360 where the player may be given the option of wagering on the secondary game. Because it may be possible for the player to lose all or part of his wager during the secondary game, it is preferable to allow the player to opt not to play. However, in most embodiments, the secondary game will generally offer a much higher rate of return and/or a higher jackpot than can be achieved on the base game. Therefore, the “smart” play will typically be for the player to play the secondary game at every opportunity. If the player opts not to play the secondary game by declining to wager at step 360, the game proceeds to step 380 to make any base game payouts. If the player does wager on the secondary game, the amount of the wager will preferably be determined before the gaming device 100 proceeds to step 365 where the secondary device 30 is initiated. Whether the secondary game is a bonus game or not, at step 370 the gaming device 100 determines the result of the secondary game. This may be performed by using any of the improved methods disclosed herein or using any other suitable method, including those currently known in the art. Once the result of the secondary game is determined, the gaming device 100 proceeds to step 380 where payouts resulting from the base game and the secondary game are made.

### Trigger Events

### Predetermined Trigger Symbols—Embodiment T1

Referring again to FIG. 1A, an embodiment of the present invention using the prior-art predetermined symbol trigger methodology will now be briefly described. In this embodiment of the present invention, the gaming device 100 triggers a secondary game, which may be a bonus game, if a player achieves a secondary triggering or qualifying condition during play of the base game. The trigger or qualifying event is either a single predetermined initiation symbol 60 landing on a designated position of the base reels or multiple predetermined initiation symbols 60 lining up in a certain predetermined pattern including a “scatter” pattern on the gaming device 100 during play.

### Varying Trigger Symbols—Embodiment T2

Referring now to FIG. 1B, an embodiment of the present invention using varying trigger symbols will now be described. The gaming device 100 includes a trigger symbol indicating light box 185 that displays a plurality of the symbols from the set of symbols 175 also appearing on the base game reels. The gaming device 100 may selectively indicate one or more of the symbols displayed on the trigger symbol indicating light box 185 by lighting an appropriate portion of the trigger symbol indicating light box 185. Preferably, for each spin of the base game, the gaming device 100 will randomly select one symbol on the trigger symbol indicating light box 185. Alternatively, more than one symbol may be selected. The trigger symbol selection may occur prior to the reels of the base game being initiated or after their initiation, but preferably is completed prior to any reel on the base game completing its spin. Because each symbol in the base game will have a specific frequency of occurrence, the relative probability of selecting any given symbol on the trigger symbol indicating light box 185 may be weighted such that there will, on average, be a desired number of successful triggers in a given number of spins. Once the initiation symbol has been selected and indicated on the trigger symbol indicating light box 185 and the base spin has been completed, the gaming device 100 determines if the base spin contains the selected trigger in an appropriate number and position. For instance, it may satisfy the trigger condition if just one of the selected trigger symbols appears anywhere on the base game reels. Alternatively, at least three of the selected trigger symbols (or any other suitable number) may be required to be on an active pay line or in another configuration to satisfy the trigger condition.

As an alternative to the gaming device 100 randomly selecting the trigger symbols for each spin, the player may be allowed to select from a plurality of trigger symbols. This may be done by successively indicating each symbol on the trigger symbol indicating light box 185 and then by stopping the successive indications when the player hits the primary spin button 145. It should be noted that if the symbols on the trigger symbol indicating light box 185 were alternately lit and extinguished in a quick and unpredictable pattern, the player could still choose when to select a trigger symbol, however, the actual symbol chosen could either be completely or partially under the control of the gaming device 100. Such an embodiment may be preferred to give the player a greater illusion of control over the game. As an alternative to the foregoing methods, as shown on FIG. 1E, the player may select his trigger symbol for a given spin by using other input means, such as a plurality of symbol selection buttons 145a, 145b and 145c. These buttons 145a, 145b and 145c, are preferably each associated with a single symbol by an icon 146a, 146b and 146c and may also initiate the base spin.

Regardless of the method used, if the player is allowed to select which symbol is to serve as a trigger symbol for any given spin, it will be appreciated by those skilled in the art that it is no longer possible to weight the selection of the trigger symbol on the trigger symbol indicating light box 185 as compared to the frequency of symbols on the base game to achieve the desired number of successful triggers. This may be remedied by altering the number or pattern/combination of trigger symbols required on the base game for a successful trigger as a function of the symbol chosen. For instance, if the player chooses a relatively rare symbol such as a “7” as a trigger symbol, he may only be required to achieve one “7” on the base game to advance to the secondary game. If one or more “7's” will occur on the base game every one-hundred spins, the player will have a successful trigger every one-hundred spins. Alternatively, if the player chooses a relatively frequent symbol such as a Cherry for a trigger symbol, he may be required to hit four Cherries in one spin to have a successful trigger. Although the probability of hitting one Cherry on a spin may be 25%, the probability of hitting four or more Cherries on a pay line or other pattern in a spin may still be one in one-hundred. Thus, the number of secondary games initiated, and more importantly the expected value of the secondary game, will remain stable regardless of which symbol the player selects as his trigger symbol for a given spin.

As an alternative to varying the number of trigger symbols required when the player is allowed to select his trigger symbol in order to maintain a stable probability of a successful trigger, it is possible to maintain a stable expected value for the secondary game while allowing the symbol selected as the trigger symbol to alter the probability of a successful trigger. This may be accomplished by varying the expected value associated with a successful trigger in an inverse proportion to the probability of a successful trigger. Although there are a number of ways to accomplish this, two of the simplest are to vary the number of activations of the secondary device that are awarded for a successful trigger or to multiply the result of a secondary game by some factor. As an example of the first method, if the player is required to hit three trigger symbols in order to play the secondary game regardless of the symbol chosen, and the probability of a successful trigger when choosing the “7” symbol is 1/300 and the probability of a successful trigger when choosing the Cherry symbol is 1/100, the player may be awarded three activations of the secondary device 30 when “7” is the trigger symbol and one activation when a Cherry is the trigger symbol. As a result, regardless of which symbol is chosen, the player will be awarded three spins of the wheel 40 every three hundred spins of the base game. Using the same trigger probabilities as the in the previous example, the second method of stabilizing the expected value of the secondary game using multipliers is easily explained. In this method, assuming that the secondary game is a bonus game, the player's win amount resulting from a secondary spin using “7's” as a trigger symbol will be multiplied by three, while the win amount resulting from a secondary spin using Cherries as a trigger symbol will be multiplied by one. The net result is that, when using “7” as a triggering symbol, as opposed to a Cherry, the bonus game will occur one-third less frequently, but the expected payout will be three times as great. It should be understood that these methods for stabilizing the expected value associated with the secondary game could also be used as desired or needed when the trigger symbols are randomly selected by the gaming device 100.

Although FIG. 1B shows a gaming device 100 with a trigger symbol indicating light box 185 for indicating which symbol has been selected as the trigger symbol for a particular spin, many other indication methods may be used. For instance, as shown on FIG. 1D, the video display 105 can display an icon 187 to indicate which symbol has been selected as the trigger symbol for a particular spin. Preferably, the symbol indicated by this icon 187 will be displayed before the base spin has completed.

### Multiple-Spin Trigger—Embodiment T3

Referring now to FIG. 1C, an embodiment of the present invention that uses multiple spins to satisfy the trigger condition for the secondary game will now be discussed. It will be appreciated that the only difference between the gaming device 100 shown in FIG. 1C and the device 100 shown in FIG. 1A is that the former includes a trigger symbol collection light box 186. The trigger symbol collection light box 186 contains six icons matching the predetermined initiation symbol 60. The number of icons on the trigger symbol collection light box 186 represents the number of initiation symbols 60 that need to be collected to complete the trigger condition. As the player plays the base game, initiation symbols may form part of the base reel results. Depending on the rules of the game being played, each occurrence of an initiation symbol 60 in the base game may result in an additional icon on the trigger symbol collection light box 186 being lit. Alternatively, the rules of the game may require that the initiation symbols 60 be on a pay line or in a particular pattern on the base game in order to light an additional icon on the trigger symbol collection light box 186. As another alternative, the rules may require that a combination of initiation symbols 60 (i.e., two or more initiation symbols 60) be hit in order to light a single icon on the trigger symbol collection light box 186. And although some combinations may only light a single icon (e.g., two initiation symbols 60) other combinations (e.g., four initiation symbols 60) may light more than one icon on the trigger symbol collection light box 186. Preferably, this is done according to a predefined pay table that is readily made available to the player.

In the preferred embodiment shown, each occurrence of a predetermined initiation symbol 60 in the base game results in one icon on the trigger symbol collection light box 186 being lit. Because the number of initiation symbols 60 needed has arbitrarily been set to six, it is assured that the player will need at least two spins of the base game to satisfy the trigger condition where the base game is a typical 3×5 video slot and each of the five video reels cannot display more than one initiation symbol 60. However, it should be appreciated that any number of initiation symbols 60 could be required. Also, although FIG. 1C shows a trigger symbol collection light box 186, this information could also be conveyed to the player by a similar image on the video display 105 or another suitable medium.

While the preferred embodiment shown in FIG. 1C uses a predetermined initiation symbol 60, it should be appreciated that the game may be modified such that the trigger symbols vary from spin to spin of the base game or from one successful completion of the trigger condition to the next. In the latter variation, a trigger symbol could be chosen by the gaming device 100 in a preferably random fashion or chosen by the player after the previous trigger condition was satisfied. Thus, in order to achieve the next trigger condition, potentially a different set of trigger symbols would need to be collected. In the former variation, where the trigger symbols collected vary from spin to spin, the preferred embodiment would maintain a level of progress toward the completion of the trigger condition from one spin to the next. For example, if immediately prior to an Nth spin, the player had collected three trigger icons on the trigger symbol collection light box 186, on the Nth spin the gaming device may randomly determine that the initiation symbol for the Nth spin is going to be a Cherry. If the player hits two Cherries on the Nth spin, at the conclusion of the base spin the trigger symbol collection light box 186 will be updated to reflect that five trigger symbols have been collected. And if on the next spin, another symbol (other than, or the same as the previously selected Cherry) is selected as the trigger symbol and the player hits one or more of these symbols on the base spin, the trigger condition will have been satisfied and the player will have the opportunity to play the secondary game.

Returning now to the first preferred embodiment using a multiple-spin trigger, the number of spins in which the player is allotted to collect the predetermined initiation symbols 60 is unlimited. However, in other embodiments, a limit is placed on the number of spins in which a player may satisfy the trigger condition. If the trigger condition is not satisfied within the limited period, the player will experience a penalty. For instance one or more of the icons, or possibly all of the icons, on the trigger symbol collection light box 186 may be extinguished. In one embodiment, the limited period is predetermined. For instance ten spins or thirty seconds after the first icon on the trigger symbol collection light box 186 is lit. In another embodiment, the limitation is determined randomly. For instance, after the first icon on the trigger symbol collection light box 186 is lit, the player may randomly be allotted between five and twenty spins to complete the trigger condition. The random determination of the limit may be weighted as desired. And in some embodiments, it may be possible to adjust the expected value associated with completing the trigger condition and playing the secondary game based on the size of the limitation as was done in the varying symbol initiations described previously. In fact, using these same methodologies, in some embodiments, the player may select or influence the size of the limitation in effect. In all embodiments where a limitation on the period for completing a trigger condition is used, preferably the limitation (e.g., time or spins remaining) is immediately and constantly communicated to the player. It will be appreciated that by placing a limitation on the period in which a player may satisfy a trigger condition that the player will experience a heightened sense of excitement toward the end of the limitation if he is also close to completion.

Although the previous embodiments described placed a limit in total on the completion of the multi-spin trigger condition (e.g., ten total spins), it is also possible to place limitations on individual symbols that are collected as described in U.S. Pat. No. 6,203,430 incorporated herein by reference. For instance, in one embodiment, each symbol will have an associated life span (e.g., ten spins). At the conclusion of a symbol's life span, a corresponding icon on the trigger symbol collection light box 186 would be removed. This life span may be predetermined and may be the same for all symbols. Alternatively, different symbols may have different life spans. As an alternative to predetermined life spans, the life span may be determined randomly, for instance by reference to the result of the base spin where the symbol was generated. In another embodiment, each symbol has a “half-life” probability associated with it. This is the probability that the symbol will be extinguished at the conclusion of a given time period (e.g. one spin). Thus, if a symbol has a half-life probability of 10% per spin, there is a 10% chance that after each spin of the base game, the symbol will expire.

Whether the limitation placed on completing the trigger condition is in total or is symbol specific, in some embodiments the limitation can be extended. Preferably, this occurs as a result of spins of the base game. For instance, one symbol on the base game reels may be designated as an extension symbol. The occurrence of the extension symbol on a base game spin may extend the limitation by a predetermined or random amount of time. Thus, for example, if the limitation is a total limitation of ten spins to complete the trigger condition, the occurrence of an extender symbol may add two spins to the total limitation, making the total limit twelve spins. In addition to extender symbols, other methods may be used to extend a limitation. For instance, losing spins may not apply toward the limitation. Alternatively, the rules of the game may be established such that a series of losing spins extends the limitation. For instance, any time the player experiences three or more losing spins of the base game in a row, the limitation may be extended by six spins. By extending the limitation by more than the number of losing spins experienced in succession (in this case two times the number of serial losses), the game thus provides the player with a positive benefit for a prolonged losing streak.

In some embodiments a player's progress toward the completion of a multi-spin trigger may be player specific such that a player can cash-out from a machine and return to either the same machine or another machine offering the same or a compatible secondary game and pick up the progress toward the multi-spin trigger where it was left off. The data related to the player's progress can be stored on a ticket or a player tracking card.

### Non-Symbol Based Trigger—Embodiment T4

In addition to the variety of new and known symbol-based trigger events described above, the methods of the present invention may be used in conjunction with other triggers, such as, but not limited to the initiators described in Australian Patent Application Nos. 2001100032 and 2001100033, incorporated herein by reference. These patent applications disclose a non-symbol based trigger where a player is assigned a value range based on the amount of his bet, and a random number is selected in a second predetermined value range that encompasses the assigned value range. If the random number is within the assigned value range, the trigger is successful. As an alternative to providing a player with a value range to randomly hit, it is also possible to select an nth coin or spin from a given value range, and, when the player eventually wagers the nth coin or completes the nth spin of the base game, the trigger is successful.

### Activation Options

Following the occurrence of a successful trigger condition, the present invention may present the player with a variety of activation options. These options will now be discussed in detail.

### Bonus Game—Embodiment A1

The first activation option is not really an option, but is a known method of playing a secondary game that may be used with other aspects of the present invention. This method is to provide the player with a bonus game following a successful trigger. Referring to FIG. 4, the potential to incorporate a bonus game into the present invention is indicated at step 350 where the game determines if the player is required to place a wager on the secondary outcome. If no wager is required, the game proceeds to step 355 where the secondary device 30, now more particularly a bonus device is activated. Because a player cannot lose money playing the bonus game, typically the player will not be given the option of not activating the secondary device 30. However, psychologically it may be desirable to allow the player to control when the secondary device 30 is initiated by requiring the player to depress a secondary spin button 147 as shown on FIG. 1A.

### Secondary Wagers

In the preferred embodiments of the present invention, following a successful trigger condition, the player is given the option of placing a wager on the secondary game. Referring to FIG. 4, if the player opts not to wager on the secondary game at step 360, the gaming machine 100 will forego the secondary game. The player may indicate his decision by using any number of input means. For instance, if the player desires not to play the secondary game, he may be instructed to activate the cash out button 180. While if he does desire to play the secondary game, he may be instructed to activate the secondary spin button 147.

In the preferred embodiments, the player will be encouraged to play the secondary game at every opportunity. This may be done by offering a large jackpot prize that is only available on the secondary game or, the secondary game may be designed such that it will always or nearly always be to the player's advantage, relatively speaking, to play the secondary game as opposed to the base game. Stated another way, the expected return of the secondary game will be higher than the base game. Thus, if the base game has an expected return of 0.80, the secondary game may have an expected return of 0.90. However, in the most preferred embodiments, the expected return associated with the secondary game will exceed 1.0 by a significant amount. Thus, in the foregoing example, the secondary game may have an expected return of 3.0. It will be appreciated by those skilled in the art that by limiting a player's access to a secondary game based upon the trigger conditions, it is possible for a casino to profitably offer patrons such a game with a total expected return of less than 1.0.

In order to ensure that a player may have sufficient finds to play the secondary game at every opportunity, it may be desirable to make an award to the player based upon the successful completion of a trigger. This award may in turn be used to wager on the secondary game. The amount of the award may be predetermined (e.g., thirty credits) or it may be a randomly determined amount. When the amount of the trigger award is randomly determined, it will preferably be selected from a range of amounts with a pre-established minimum and maximum amount. Preferably, the trigger award will be equal to or greater the maximum amount that the player may wager on the secondary game.

In addition to these variations, the type of secondary wager the player can optionally place can generally be separated into one of two forms, fixed or variable. Each of these variations to the preferred embodiment will now be discussed in turn.

### Fixed Secondary Wager—Embodiment A2

In the embodiment where the player may optionally activate the secondary game by placing a fixed secondary wager, the wager amount is predetermined and does not vary from one spin to the next. This amount is preferably communicated to the player on the face of the gaming machine 100, for instance on the pay table.

Referring now to FIGS. 1B, 4 and 5, a specific application of this embodiment will now be described. The gaming machine 100 in FIG. 1B randomly determines which symbols will serve as initiation symbols for a given spin. As previously described, the symbol selected is indicated to the player by the trigger symbol indicating light box 185. For the purposes of this example, the “7” symbol will be selected and three or more 7's anywhere on the video display 105 will trigger access to the secondary game. Additionally, in conjunction with the successful trigger, the player will receive a trigger award of thirty credits. The thirty credits awarded for the trigger may be in addition to any awards due from the base spin, including awards resulting from reel combinations involving 7's. Alternatively, at the preference of the operator or manufacturer of the gaming machine 100, if the same 7's that satisfy the trigger condition also result in a winning combination on the base spin, the player may only be awarded the higher of the two awards. Or, in another alternative, the gaming machine 100 may only award the player with the higher of thirty credits for the trigger and the sum of the awards from all of the symbols displayed on the base spin. The video display 105 shown on FIG. 1B displays four 7's. Therefore, the trigger condition was satisfied and, assuming no other winning combinations, the player is awarded thirty credits and the credit display 140 is incremented accordingly.

Referring now to FIG. 4, the player is at step 360 presented with the option of wagering thirty credits on the secondary device 30. In this example, the player chooses to make this wager by activating the secondary spin button 147. As a result, the credit display 140 is decremented by thirty credits and the wheel 40 in the secondary device 30 begins to rotate at step 365. As will be described in greater detail below, the wheel 40 has sixteen positions, each indicating a value to be awarded to the player. On the gaming machine 100 shown on FIG. 1B, one such position will be selected and the associated value will be awarded to the player. In the example shown on FIG. 1B, these values range from twenty and twenty-five credits on the low end up to five-hundred and one thousand credits on the high end. Thus, it is possible for the player to lose up to ten of his wagered credits and for the player to win up to nine-hundred and seventy additional credits. It would also be possible to provide a wheel 40, with a zero value position, such that the player could lose his entire wager.

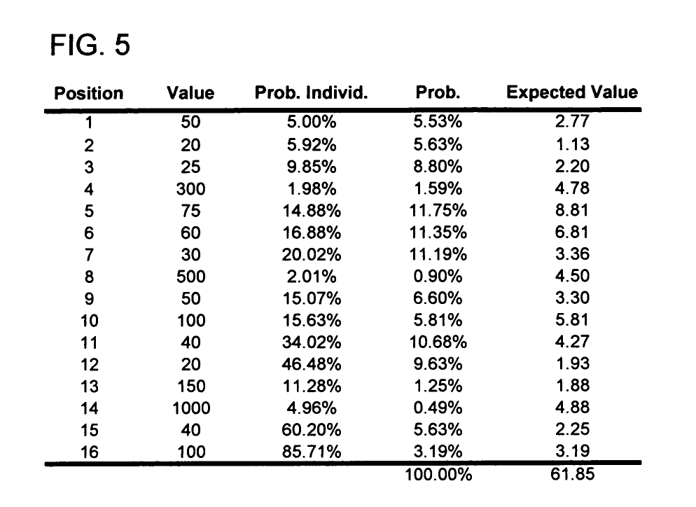

Referring now to FIG. 5, the probability of each position being selected using one of the selection methods disclosed are shown. The table in FIG. 5 also discloses the expected value associated with one activation of the wheel 40. This expected value is slightly greater than sixty credits. Thus, in the described hypothetical example, the expected return of a thirty credit wager on this secondary game would be slightly greater than 2.0.

### Variable Secondary Wager—Embodiment A3

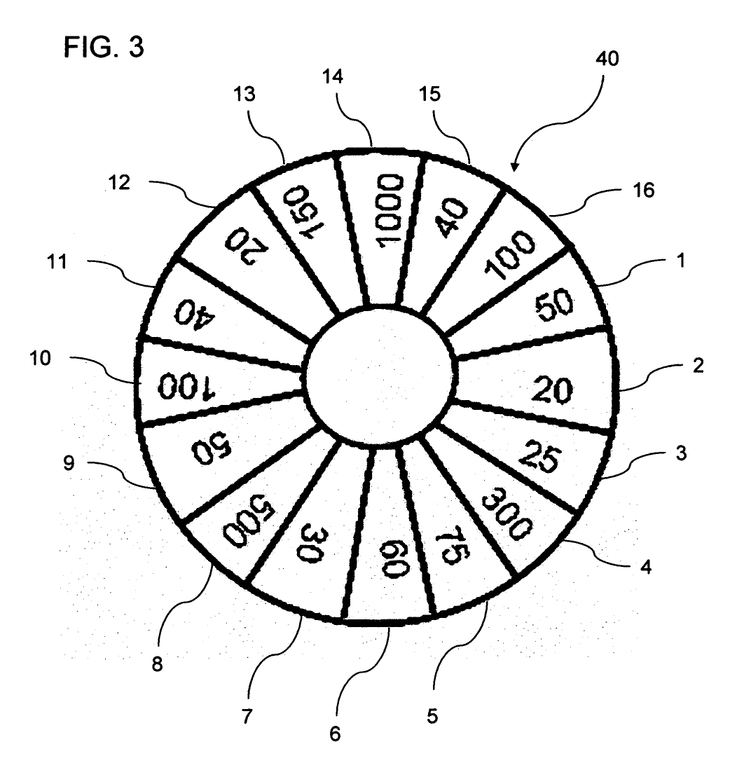

As an alternative to having a fixed secondary wager amount, the gaming machine 100 may allow a player to place a secondary wager that varies in amount from game to game or from trigger to trigger. In such an embodiment, the exact amount wagered may be determined by the game, the player or some combination thereof. Although the game may determine the amount to be wagered, it will preferably still be up to the player to decide whether or not he wants to wager the prescribed amount.

Where the amount to be wagered is determined by the game, the game may randomly select an amount from a range of pre-established values. The selection may be weighted. Preferably the limits of the pre-established values will be between the maximum and minimum amounts that may be won on the secondary game. And most preferably the amount selected will be weighted such that it is approximately equal to, or less than, the gross expected value of the secondary game. For example, referring to the probabilities and expected values shown on FIG. 5, a gaming machine 100 according to the present embodiment could select a wager amount between twenty and sixty credits and weight the selections such that the average amount selected was thirty credits. As an alternative to randomly selecting a prescribed amount to wager on the secondary game, the gaming machine 100 may require the player to wager an amount on the secondary game equal to all or a portion (e.g., one half) of the player's winnings, if any, from the last base spin. Thus, where there are no winnings on the base spin resulting in the successful trigger, the secondary game would be a bonus game requiring no wager. However, if the player won a jackpot on the base game (e.g., ten thousand credits) and also completed the trigger condition, the required wager could be very high. Although a player would never risk ten thousand credits to win one of the amounts shown on the wheel 40 in FIGS. 1A to 1E, is should be appreciated that if the amounts on the wheel 40 were multiplied by the amount wagered to determine the secondary payout, and if the wheel 40 contained one or more positions with a zero value, such a wager may be very exciting and attractive to a player.

Where the amount to be wagered is determined by the player, preferably the player is allowed to choose a secondary wager amount between a minimum and maximum amount. In order to encourage the player to wager more on the secondary game, it may be preferable to either designate some of the possible prizes in the secondary game as ineligible unless a player wagers a certain amount. For instance, where the player is given the option of making a secondary wager of one, two or three times the amount wagered on the base spin at the time the trigger is completed, certain positions may only be active for higher bet amounts. Referring to FIG. 3, if the player wagers three times the base wager, all positions may be active. While if the player wagers two times the base wager, a one thousand credit spot 14 and a five-hundred credit spot 8 on the wheel 40 in FIG. 3 may be deactivated. Further deactivations may occur for only wagering one times the base wager. It would also be possible to multiply the amounts on the wheel 40 for every additional unit wagered. Thus, if the player may chose a secondary wager of one, two or three times the base wager, the amounts on the wheel 40 would be increased by one, two or three times respectively. Because the expected return of the secondary game is preferably greater than the base game and most preferably greater than 1.0, it will be appreciated by those skilled in the art that players will be encouraged to wager the maximum amount allowed on the secondary game where the payout is proportional to the wager.

### Value Determination

Once the trigger condition has been satisfied and, where necessary the player has opted to wager a secondary amount on the secondary game, the gaming machine 100 of the present invention will proceed to steps 365 and 370 on FIG. 4, where the secondary game is initiated and the result is determined. In the preferred embodiments the secondary game involves a mechanical secondary device 30 that includes a wheel 40. After the player initiates the secondary game or in the case of a self-initiating secondary game, after a desired amount of time passes, the wheel 40 begins to spin. The processor 200 is operatively connected to the wheel 40 preferably by a stepper motor or by any other means known by those in the art. This operative connection not only allows the processor 200 to initiate the spinning of the wheel 40, but also allows the processor 200 to monitor the wheel's position while it is being spun and to stop the wheel 40 at any desired position, the stop position. The stop position of the wheel 40 may be determined using known virtual mapping techniques or in accordance with one of the embodiments described below. Once the wheel 40 stops preferably a pointer 50 indicates a value that the player has won as a result of the activation of the secondary device 30. The value indicated is awarded to the player and the credit meter 140 may be incremented accordingly. The gaming device 100 may continue to provide an additional secondary game to the player using either the secondary device 30 or another form of secondary game known in the art or it may return to normal operation.

Referring now to FIG. 3, the wheel 40 has been divided into sixteen areas numbered 1 to 16. Each area has one secondary value ranging from twenty to one thousand. These secondary amounts may be gross credit amounts awarded to the player if the secondary area is selected or may be amounts that are multiplied by the number of credits bet per line on the base game, the number of lines bet on the base game, or any combination thereof, including the total amount wagered on the base game or the amount wagered on the secondary game.

### Individual Evaluation—Embodiment V2

FIG. 5 illustrates the first embodiment according to the present invention, referred to generally as individual evaluation. In this embodiment, each of the sixteen areas of the secondary wheel 40 is assigned an individual probability of success shown on FIG. 5. For instance, as indicated in FIG. 5, the area containing a three-hundred credit amount 4, has an individual probability of success of 1.98% while the area containing a first thirty credit amount 7, has an individual probability of success of 20.02%.

As the wheel 40 is spinning the processor 200 monitors which of the wheel's areas is currently being indicated by the pointer 50. As the wheel 40 is spinning, the processor 200 generates a series of random numbers between 0 and 1 using the RNG. Preferably, exactly one random number is generated each time a new area is indicated on the wheel 40. The most recent random number generated is then compared to the individual probability associated with the area currently being indicated. If the random number is equal to or less than the individual probability (i.e., a successful trial), the processor 200 will stop the wheel 40 at the current position.

Because the processor 200 is evaluating each area of the wheel 40 on an individual basis, it may be preferable to spin the wheel 40 at a sufficiently slow speed. A relatively low speed also has the added benefit of allowing the player to comprehend which area of the wheel 40 is being indicated at any given time. In one preferred embodiment the speed of the wheel 40 is reduced incrementally after each unsuccessful trial. In addition, it may be desirable to initially spin the wheel 40 at a high rate of speed where no trials are being attempted. This portion of the spin where no trial is attempted is provided primarily for the amusement of the player and may last for a random or predetermined amount of time or number of rotations. In the preferred variation of this embodiment, the first trial is always attempted on the same reference position, arbitrarily position 1. In an alternative variation, the first position to be tried may be randomly selected after the wheel 40 is spun for an initial period.

The mathematical properties represented by FIG. 5 represent the previous variation where the first trial is always performed on a first reference point. Therefore, the probability of stopping the wheel 40 at the first area 1 on the first attempt is 5%. The probability of the secondary device 30 stopping the wheel 40 at the second area 2 on the second attempt can be calculated as the probability of an unsuccessful previous trial (95%) times the individual probability of the second area 2 (5.92%). This yields an effective probability of 5.63% for the second area 2. The effective probability listed on FIG. 5 is the probability of each area and corresponding secondary amount being selected prior to the initiation of the secondary device 30. Based on the individual probabilities in FIG. 5, there is a 0.53% chance that the wheel 40 will proceed through all sixteen areas without the processor 200 choosing a random number that yields a successful trial. In the embodiment shown, the wheel 40 will be stopped without generating a random number the second time the wheel 40 reaches the first area 1. Alternatively, if there is no successful trial after the first full rotation, the wheel 40 may continue to spin and individually perform trials to determine where to stop. The individual stop probabilities used for this second rotation of the wheel may be the same or different than the individual probabilities used on the first rotation.

As can be seen in FIG. 5, the effective probabilities for the higher value awards on the wheel 40 are significantly less than 1/16. Multiplying each award associated with a position by that position's effective probability yields the expected value for each individual position. By summing up these expected values for all positions, as shown in the last column of FIG. 5, the total expected value for a given spin of the wheel 40 is 61.85 credits.

### Group Method—Embodiments V3, V4 & V5

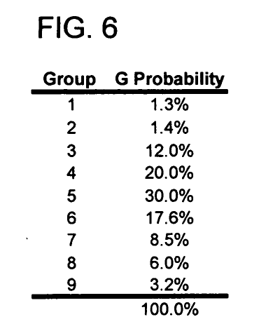

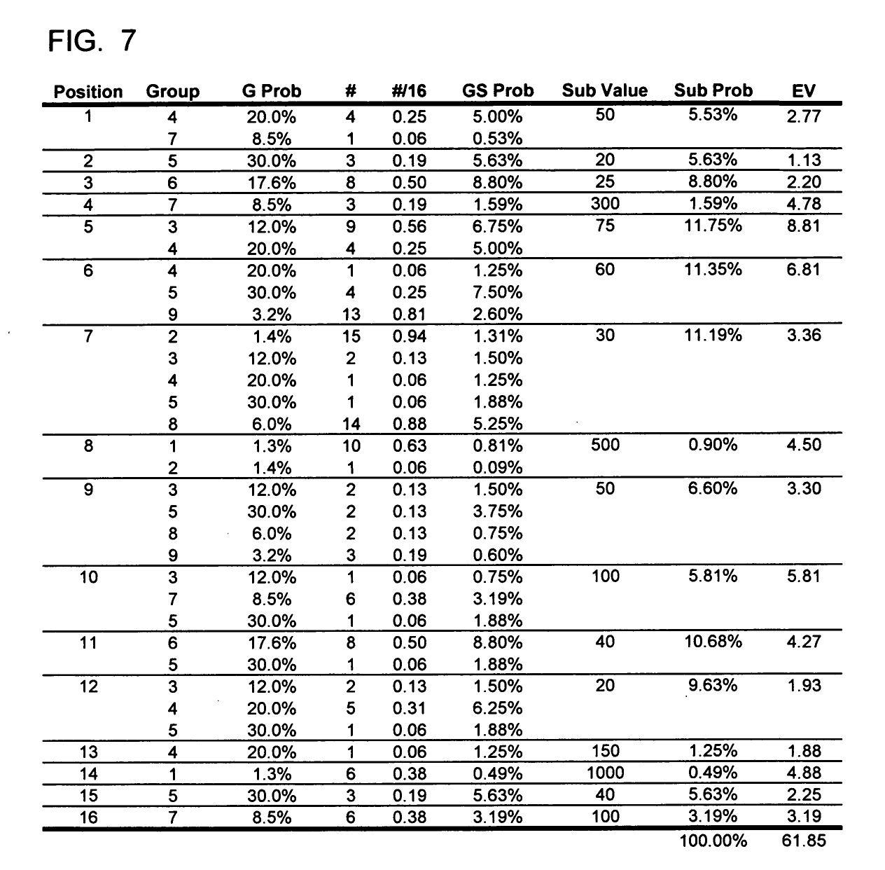

Referring now to FIGS. 6 and 7, two additional embodiments of the invention will now be described in detail. These embodiments are generally referred to as the group method of selection. Referring first to FIG. 6, nine groups have been defined and each group has been assigned a group probability. Referring now to FIG. 7, each position on the wheel 40 has been assigned to at least one, and for some positions more than one, group.

As an initial step in the play of the secondary game, the RNG is used to select one group according to the predefined group probabilities. The positions that have been assigned to the selected group are then designated as active positions while the remaining positions that are not in the selected group are designated as inactive positions. Inactive positions cannot be selected on the subsequent spin of the wheel 40.

In the first variation of the group method (i.e., embodiment V3), the wheel 40 may be rotated in preferably three modes. In the first mode, as in embodiment V2, the wheel 40 may be spun at a relatively high rate of rotation and there is no attempt to stop the wheel 40. This first mode is not essential, but is mainly used to entertain the player and “set” the wheel 40. In the second mode of rotation the wheel 40 spins for a random amount of time. The precise amount time is preferably chosen by processor 200 using its RNG. Preferably, no attempt is made to determine the ultimate stop position of the wheel 40 during this second mode. Similarly, no attempt is made to provide enhanced odds to the secondary device 30, at this time. The speed of rotation of the wheel 40 preferably changes from the initial velocity, to a slower second velocity during the second rotation mode. This change in speed may be abrupt or gradual. When the random time has expired, the wheel 40 enters the third mode of rotation. In the third mode, the wheel 40 stops when the pointer 50 indicates the next active position as determined by the previously selected group. Again the speed of rotation may decrease during the third mode in either an abrupt or gradual manner.

In the preferred variation of embodiment V3, there is an equal probability that each of the positions on the wheel 40 will be the indicated position when the secondary device 30 exits the second mode. Thus, the relative probability for each position in a given group can be calculated as a fraction with a numerator equal to one plus the number of inactive positions between a given active position and the next active position on the wheel 40 in the opposite direction of rotation and a denominator equal to the total number of positions on the wheel 40. Referring again to FIG. 7, the numerator for this fraction for each position as a function of its group is indicated in the fourth column and the fraction is in column five. Multiplying the fraction by the group probability yields an individual probability for a given group as shown in column six. Summing up all of these probabilities for a given position yields the total effective probability for any given position as shown in column eight. Multiplying the effective probability for each position by the award value yields the expected value as shown in column nine. Summing up all of the expected values yields the total expected value for a given spin of the wheel 40. As shown in FIG. 7 the effective probabilities and expected values for the exemplar group selection method has been matched to the same values derived in FIG. 5 using the individual evaluation method even though markedly different methods for achieving these results were used.

The main difference between embodiment V3 and embodiment V4 occurs when the spin enters the third mode. In embodiment V4, upon entering the third mode, rather than automatically stopping the wheel 40 on the next active position, the processor 200 will cause the wheel 40 to proceed to the next active position and will perform an individual evaluation on the position using the predetermined individual probability associated with the position as exemplified in embodiment V3. If this trial is unsuccessful, the wheel 40 will proceed to the next active position and again perform an individual trial. This process will continue until one of the positions in the group is chosen through a successful trial.

Referring now to FIGS. 3, 6 and 7 an example of how a secondary device 30 utilizing embodiment V3 of the present invention will now be described. As an initial step, the RNG in the processor 200 may produce the number 0.200. Referring then to FIG. 6, this will equate to a selection of Group 4. Referring to FIG. 7, the positions in Group 4 are 1, 5, 6, 7, 12 and 13. These positions will be designated as active. The remaining positions are deactivated. Next assume that the wheel 40 spins in a clockwise direction for a random amount of time before entering the third mode. When the secondary device 30 enters the third mode, the pointer 50 is indicating position 8 on the wheel 40. The wheel 40 keeps rotating until the pointer 50 indicates the next active position, which is position 12. Position 12 has a value of twenty. Therefore, twenty credits is awarded to the player.

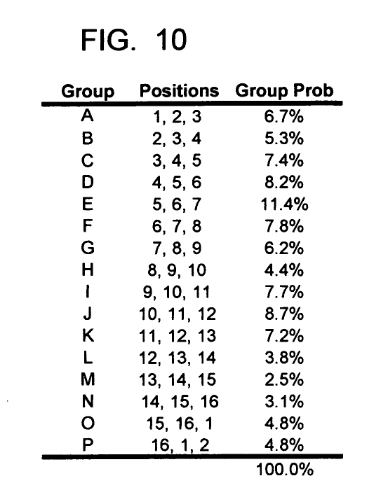

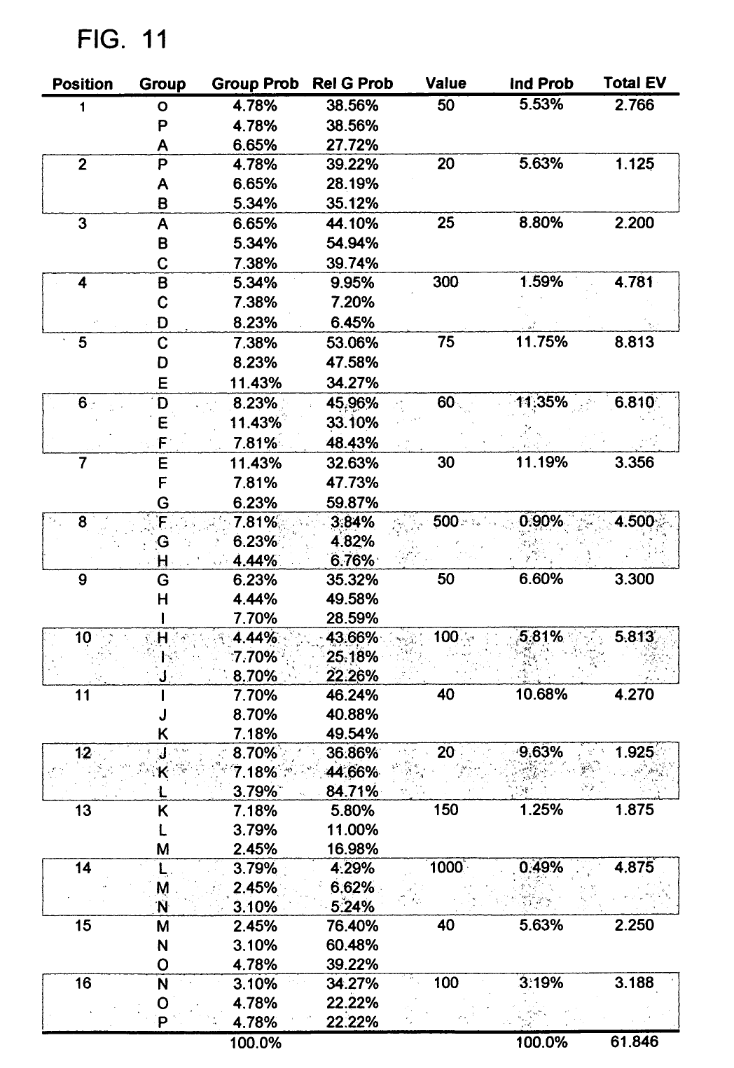

Referring now to FIGS. 1D, 10 and 11, a third group selection methodology, embodiment V5, will now be described. As in the two previous group selection embodiments, each position on the wheel 40 is assigned to one or more groups. Specifically, in the example shown on FIG. 10, there are sixteen groups arbitrarily labeled A through P. Each position is assigned to three groups, such that each group contains three positions. The third column of the table shown in FIG. 10 gives the probability of selecting a group as before. However, unlike in the previous group selection embodiments, once the gaming machine 100 has selected a group, the processor 200 will stop the wheel 40 such that each of the positions on the wheel 40 in the selected group is adjacent to one of the selectively activated pointers 50a, 50b and 50c shown on FIG. 1D. The processor 200 will then alternately illuminate each of the selectively activated pointers 50a, 50b and 50c for a brief period. At the end of this period, the processor 200 will randomly select one or more of the positions within the selected group according to predetermined relative group probabilities as demonstrated by column four of FIG. 11. The processor 200 will then constantly illuminate the associated selectively activated pointer 50a while extinguishing the other pointers 50b and 50c to indicate the prize awarded to the player.

Although three selectively activated pointers were used, it should be appreciated that a single pointer relatively movable along the periphery of the wheel 40 could be used instead. However, by illuminating stationary pointers, the player is given a clear image of which eligible positions comprise the selected group. It should also be understood that the number of pointers used may be changed according to the manufacturer's desire without altering the invention. Further, it is not necessary for each group to have the exact number of positions within it as number of pointers provided. Referring again to FIG. 11, the gross probability of a specific position being selected using this method can be calculated as the sum of the product of the group probability and the relative group probability for each group that the position is in. This information for the disclosed preferred embodiment is shown in the sixth column of FIG. 11.

Those familiar with gaming will appreciate that one of the advantages achieved by this method of selection is that positions such as the one-thousand credit position 14 may be placed in groups that occur relatively frequently, while the actual position is still very infrequently selected. For instance, as shown on FIG. 11, the one-thousand credit position 14 will be selected 0.49% of the time, just as it was using the other methods disclosed, however the one-thousand credit position 14 will be in the selected group (i.e., group L, M or N) over 9% of the time. Thus, on approximately every eleventh spin of the wheel 40, the player will perceive that the top award of one-thousand credits is one of three possible awards that the player will win. This will add to the enjoyment and excitement that the player experiences when playing the game.

### Elimination Method—Embodiments V6 & V7

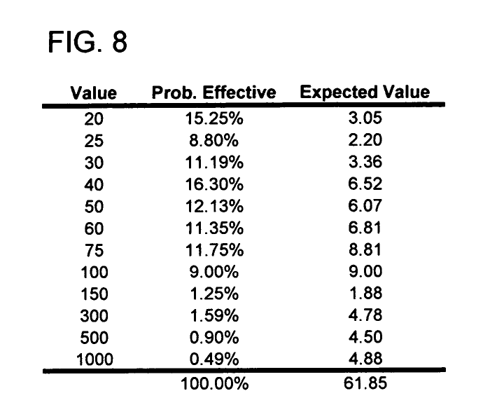

In another embodiment, after the processor 200 has activated the secondary device 30, the processor 200 uses its RNG to determine a maximum secondary award amount, Bmax. The maximum secondary award amount is the total amount that will be awarded to the player. The selection of Bmax is made using enhanced odds in any one of several manners well known in the art. As an example, FIG. 8 shows possible associated probabilities for the selection of Bmax. After Bmax is chosen, all positions with corresponding secondary values greater than Bmax on the wheel 40 are designated as inactivate. Additionally, other positions may also be deactivated for reasons that will be made clear later in the description.

In the first variation of the elimination method, embodiment V6, once the positions on the wheel 40 with values greater than Bmax are designated as inactive, the processor 200 will cause the secondary device 30 to indicate a first position, chosen from the remaining active positions. The secondary amount associated with the first selected position is designated as Bfirst. If Bfirst is less than Bmax, the player will be awarded another activation of the secondary device 30. In the next activation of the secondary device 30, additional positions on the secondary device 30 will be designated as inactive, such that any position with a value greater than the difference between Bmax and Bfirst is inactive. Other positions may also be deactivated. This iterative process will continue n times until the sum of Bfirst to Bnth is equal to Bmax. After each iteration additional positions will likely be deactivated.

Each additional activation of the secondary device 30 can be presented to the player in any number of ways. It may just be presented to the player as a gratuitous extra “lucky” spin or the player may play an intermediary game to “earn” the extra spin. For instance, the player may be asked to guess if the next card off of a virtual deck of cards is going to be red or black. Each time the player guesses correctly, he will be awarded an extra activation of the secondary device 30. The player will “guess” correctly until such time as the player's total awards from the secondary device 30 total Bmax. After this time, the player will guess incorrectly. Alternatively, the player may push a button to flip a virtual “lucky coin” with one side marked “Spin Again” and the other side marked “Game Over.”

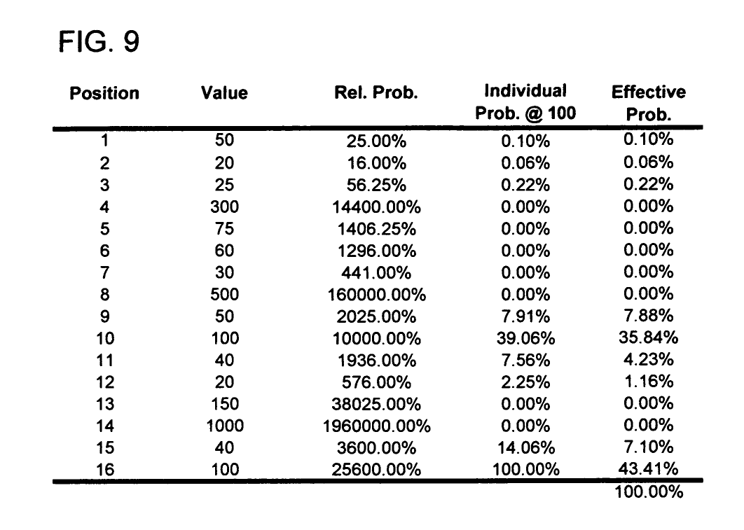

The actual stop position of the secondary device 30 can be selected in any number of ways. For instance, the stop position may be determined using the individual evaluation method as described in embodiment V2. When individual evaluation is used, it is preferable that the individual probabilities of each stop position will be proportionally related to the value of the position, such that stop positions with higher values will generally have a higher individual probability. Once at least the positions with a value higher than the maximum allowed value for each spin are eliminated, the individual probabilities of the active positions will preferably be normalized such that the highest active value has an individual probability near 90%. Referring now to FIG. 9, the initial relative individual probabilities of each position is indicated in column three of the table. These initial probabilities are based on the square of the position number multiplied by the square of the position's secondary amount divided by ten thousand. Assuming that Bmax has been set at one hundred, the normalized individual probabilities for the first activation of the secondary device 30 are shown in column four of FIG. 9.

Alternatively, the actual stop position of the secondary device can be determined by using a random spin time to select the first available stop position as was performed for embodiment V3. In this alternative, the wheel 40 spins for a random amount of time upon the activation of the secondary device 30. As in previous embodiments, the activation of the secondary device 30 may either be automatic or in response to some player interaction, e.g., the depressing of the secondary spin button 147. Also as in previous embodiments, the spinning of the wheel 40 can be choreographed in any number of ways to entertain the player and increase the anticipation of the secondary event. This may preferably include initially spinning the wheel 40 at a relatively high rate of speed and then later slowing it to indicate that it will soon stop. This change in speed may also be accompanied by audible indications that the wheel 40 will soon stop. As in previous embodiments, the amount of time for which the wheel 40 spins is not chosen in any particular effort to cause the wheel 40 to stop spinning so as to indicate any particular position on the wheel 40. Once the random amount of time has passed, the processor 200 will stop the wheel 40 at the next active position.

For example, assume that the RNG selects a secondary award amount Bmax=50. Upon activation of the secondary device 30, the wheel 40 spins in a clockwise direction. When the random amount of time has passed, the pointer 50 is indicating position 6, which in this example corresponds to a secondary amount of sixty. Therefore, this is an inactive position. The wheel 40 keeps spinning until the pointer 50 indicates the next active position. In this example, as the wheel 40 is spinning in a clockwise direction, the next position which is less than Bmax, i.e., fifty, is position 3. Position 3 has an associated value of twenty-five. Once the wheel 40 stops at position 3, the player will be awarded another spin where the only active position will preferably be position 3. Note that positions 2 and 12 could also be active, but if these positions (with a value of twenty) were selected, there would be no position on the wheel 40 that could award the remainder of five credits.

In embodiment V7, another alternative embodiment of the elimination method, Bmax and the initial result of the secondary device 30 are chosen as before. However, if there is a difference between the initial result and Bmax, the player is not necessarily awarded another activation of the secondary device 30. Rather, the difference between Bmax and the initial award amount is provided to the player by awarding an additional secondary amount that does not require a second activation of the secondary device 30. This additional amount may be provided to the player by playing, for instance, a secondary game commonly known as a second screen bonus. One such second screen bonus that is well known and widely utilized in the gaming industry is described in U.S. Pat. Nos. 6,089,976; 6,015,346; 6,261,177 and 6,190,255, incorporated herein by reference. Also, it is not necessary that the player actually play a secondary game at all to receive the additional amount. In one alternative embodiment, following the activation of the secondary device 30, the gaming device 100 may simply inform the player that in addition to the initial amount, the player will be awarded “X” credits, where X is the difference between Bmax and the initial amount.

While this invention has been described with respect to several specific embodiments thereof, it should be understood that the invention is not limited to the disclosed embodiments, but rather that the invention is intended to cover various combinations, modifications and equivalent arrangements which will be apparent to those skilled in the art. It is thus to be understood that the invention should not be limited by the description, and that modifications and variations in the present invention may be made without departing from the novel aspects of this invention as defined in the following claims.

1. A gaming device comprising:
a wager accepting mechanism;
a payout mechanism;
a wagering device for allowing a player to make a base wager and a secondary wager;
a plurality of reels, each of said reels having at least one symbol thereon, and at least one of said reels having a plurality of symbols thereon such that the plurality of reels can display a plurality of symbol combinations;
a means for indicating at least one of the plurality of symbols on the plurality of reels as a trigger symbol;
a secondary device comprising a wheel with a plurality of regions arranged on the circumference of the wheel and at least one pointer that indicates one region of the wheel, wherein at least one of said regions has a secondary amount associated with it;
a memory for storing a set of symbol combinations, at least one of said symbol combinations being a winning combination with an associated payout, and at least one of said symbol combinations being a trigger combination;
a processor operatively connected to a random number generator, the memory, the wager accepting mechanism, the payout mechanism, the wagering device, the plurality of reels, the indicating means and the secondary device;
said processor, in response to a player placing a base wager, being programmed to designate at least one of the plurality of symbols as the trigger symbol, activate the indicating means to indicate the designated trigger symbol, spin the reels, stop the reels at a position selected by the random number generator, evaluate the symbol combinations formed by the reels for any winning combination or trigger combination and make a payout to the player if one of the symbol combinations is a winning combination;
said processor being further programmed to allow the player to optionally place a secondary wager on the secondary device in response to the occurrence of a trigger combination; and
said processor, in response to the player placing a secondary wager, being further programmed to select at least one of the plurality of regions on the secondary device and pay out any secondary amount associated with the selected region.

2. A gaming device as defined in claim 1 wherein in order to select the at least one region on the secondary device, the wheel is rotated about its axis and the processor uses the random number generator to determine a stop position for the wheel such that the at least one pointer indicates the selected region.

3. A gaming device as defined in claim 2 wherein the processor uses the random number generator to select the trigger symbol, and the odds of selecting the trigger symbol are weighted.

4. A gaming device as defined in claim 2 wherein the player selects the trigger symbol prior to the processor stopping at least one of the reels.

5. A gaming device as defined in claim 3 wherein the trigger combination is also a winning combination.

6. A gaming device as defined in claim 5 wherein the trigger combination is a scatter combination.

7. A gaming device as defined in claim 3 wherein said at least one trigger combination is a function of the at least one symbol designated as the trigger symbol.

8. A gaming device as defined in claim 1 wherein the secondary wager must be a predetermined amount.

9. A gaming device as defined in claim 1 wherein the secondary wager must be an amount randomly determined by the processor.

10. A gaming device as defined in claim 1 wherein the player selects the amount of the secondary wager from a plurality of possible amounts.

11. A gaming device as defined in claim 5 wherein the secondary wager must be a predetermined amount.

12. A gaming device as defined in claim 11 wherein the predetermined amount for the secondary wager is equal to or less than the payout amount associated with the trigger combination.

13. A gaming device as defined in claim 1 wherein the indicating means is a light box.

14. A gaming device as defined in claim 1 wherein the indicating means is a video display.

15. A method of playing a wagering game comprising the steps of:
(a) accepting a primary wager from a player at a gaming machine controlled by a processor;
(b) spinning a set of reels with a plurality of symbols on said set of reels in response to the primary wager and randomly stopping said reels to form a combination of displayed symbols;
(c) comparing the combination of displayed symbols to a predetermined set of winning combinations and making a payout if the displayed symbol combination is a winning combination;
(d) in response to the primary wager, determining if a trigger condition has been satisfied;
(e) activating a secondary game in response to a satisfied trigger condition, wherein the secondary game is played using a wheel having a circumference, a plurality of regions circumferentially arranged on said wheel, and a means for indicating at least one region in a subset of regions, wherein the subset of regions is smaller in size than the plurality of regions, and wherein one or more of said plurality of regions is associated with a secondary amount;
(f) associating each region with at least one of a plurality of groups;
(g) randomly selecting at least one group from the plurality of groups;
(h) relatively moving said wheel and said indicating means to a position such that at least one of said regions in said selected group corresponds to the subset of regions that may be indicated by said indicating means;
(i) randomly selecting one region from the selected group and indicating said selected region to the player using the indicating means, and;
(j) making a payout to the player based on the secondary amount, if any, associated with the selected region.

16. The method of claim 15 wherein the step of relatively moving the wheel and the indicating means involves rotating the wheel about an axis and stopping the wheel at a position chosen based upon the selected group.

17. The method of claim 16 wherein either the step of randomly selecting a region from the selected group or the step of randomly selecting a group is weighted such that at least one region will be selected more frequently than another region.

18. The method of claim 17 wherein the indicating means is at least one pointer that may move along an arc of the wheel after the wheel is stopped that is less than the circumference of the wheel such that the subset of regions that may be indicated by the pointer is defined by said arc.

19. The method of claim 17 wherein the indicating means is a plurality of pointers that may each be selectively activated by the processor.

20. The method of claim 19 wherein the pointers are stationary and the activation of said pointers is indicated using a light source.

21. The method of claim 16 wherein the step of activating the secondary game is played as a bonus game.

22. The method of claim 16 wherein the step of activating the secondary game requires the player to place a secondary wager, at least a portion of which may be lost on the secondary game.

23. The method of claim 22 wherein the amount of the secondary wager must be a predetermined amount.

24. The method of claim 22 wherein the amount of the secondary wager amount is randomly determined by the processor.

25. The method of claim 22 wherein the trigger condition is a preselected symbol combination.

26. The method of claim 25 wherein the preselected symbol combination contains a single preselected initiation symbol.

27. The method of claim 25 wherein the preselected symbol combination is a scatter combination.

28. The method of claim 22 wherein the trigger condition is unrelated to the combination of symbols displayed.

29. The method of claim 22 wherein the trigger condition is at least one symbol combination randomly determined by the processor in response to the primary wager.
